(19) United States
(12) Patent Application Publication
(10) Pub. No.: US 2017/0061280 A1
(43) Pub. Date: Mar. 2, 2017

(54) System for creating spatiotemporal patterns to entertain, teach and control

(71) Applicant: Georgiy Borisovich Kuznetsov, Harwich, MA (US)

(72) Inventor: Georgiy Borisovich Kuznetsov, Harwich, MA (US)

(21) Appl. No.: 15/201,499

(22) Filed: Jul. 3, 2016

Related U.S. Application Data
(60) Provisional application No. 62/210,345, filed on Aug. 26, 2015.

(51) Int. Cl. G06N 3/08; G09B 5/02; G09B 19/00; G06N 99/00

(52) U.S. Cl. CPC G06N 3/08; G06N 99/005; G09B 5/02; G09B 19/00

(57) ABSTRACT

A system to produce spatiotemporal patterns, said system comprising: a plurality of cellular automata (CAa), and a plurality of inter-cellular memories; the contents of said inter-cellular memories condition the changes in said CAa.

Once activated, said systems produce spatiotemporal patterns. Said patterns can be puzzling, aesthetically pleasing, and teaching. Said patterns can control other devices and computer programs, demonstrate the notions known in science and engineering, model real world phenomena and systems. To produce desired patterns, the users of said system edit the contents of said inter-cellular memories. To be able to do more, said users are encouraged to learn computer programming.

### CROSS-REFERENCE TO RELATED APPLICATIONS

62/210,345 Devices and methods for creating temporospatial layouts and patterns to entertain, teach and control, Aug. 26, 2015

### STATEMENT REGARDING FEDERALLY SPONSORED RESEARCH OR DEVELOPMENT

Not Applicable

### REFERENCE TO SEQUENCE LISTING, A TABLE, ORA COMPUTER PROGRAM LISTING COMPACT DISC APPENDIX

The following 10 files are to be submitted via EFS-Web together with this specification:

embodiment2_html.txt
embodiment2_js.txt
patterns_js.txt
help_html.txt
help_js.txt
nhood_svg.txt
styles0_css.txt
styles1_css.txt
normalize_css.txt
demo_css.txt
apple_svg.txt
elephant_svg.txt

### BACKGROUND OF THE INVENTION

This invention emerged from the lessons I was giving to my children. When my daughter was 2 years and 4 months old, I started building with her layouts and patterns of colors on a toy pegboard. In the beginning, I was disclosing to her my plans literally peg by peg. Following me, she could perform far beyond her own abilities, and she liked it.

Soon I started encouraging her to build complete shapes, to fill the missing parts, etc. I was also misleading her making the process of building harder than it could have been. This pedagogy became possible because I was turning spatial patterns into spatiotemporal patterns unfolding in time.

This lessons had obviously accelerated my student's intellectual development. Before she turned 5, she discovered cartesian plane, used vectors, knew long numbers, could perform long addition and subtraction. Most of this knowledge she acquired through spatiotemporal patterns. She learned to read soon after she turned 5.

To automate my job, I wrote a program simulating a network of cellular automata, turning each other “on”. A turned “on” automaton would display its secret color. To keep the toy as simple as possible and to motivate the players to learn computer programming, I avoided functionality, which would allow to build a Turing machine.

I modified the automata to make them self-timing. This enabled the patterns to restart themselves and oscillate. Exploring the capabilities of this simple model, I found numerous puzzles of various difficulty, some of which were hard even to experienced puzzle solvers.

Puzzles aside, this invention demonstrates and teaches space, time and causality in the purest forms. Playing with the system, the learners encounter signals, messages, networks, oscillation, waves, signals, cellular automata and emergence, to name but few. Said learners can engage in distinctly different activities. For example, said learners can entertain themselves creating spatiotemporal patterns, solve the problems replicating the known spatiotemporal patterns, model the natural or artificial phenomena, learn computer programming, control computer programs or external devices.

At the time of writing, this invention is answering the question that nobody asked. Spatiotemporal patterns are immensely important: We live inside them, we depend on them and we are them. Yet, spatiotemporal patterns are not being taught at preschools, kindergartens and schools.

Cellular automata (CAa) are the favorite toy of many math lovers and a source of useful models for real world. This invention is an attempt to adapt CAa to education.

### BRIEF DESCRIPTION OF THE SEVERAL VIEWS OF THE DRAWING

FIG. 1 is a circuit diagram of a simplified cellular automaton described below as Embodiment 1.

### BRIEF SUMMARY OF THE INVENTION

Invented is a system producing spatiotemporal patterns. Said system can be used in at least 4 ways. First, creating and replicating said spatiotemporal patterns can be entertaining and puzzling. Second, through modeling spatiotemporal patterns found in nature or created artificially, said system teaches space, time, causality. Third, said system is a multipurpose spatiotemporal controller. Fourth, if based on a computer, said system provides ample material and motivations for learning computer programming.

The difference between the system of this invention and the commonly studied and used cellular automata is demonstrated below. On the left, there is a plurality of cellular automata (A), wherein said cellular automata exist and operate in an isotropic space. On the right, is an example of the system taken from Embodiment 2, wherein the cellular automata are embedded in the inter-cellular medium comprising the inter-cellular memories (m). Said system provides eight inter-cellular memories per every cellular automata, and two inter-cellular memories between every two neighbor cellular automata. Hence, the relations between said cellular automata depend on their relative and absolute positions.

| | |
|---|---|
| AAAAAAAAA | mmmmmmmmm |
| AAAAAAAAA | mAmmAmmAm |
| AAAAAAAAA | mmmmmmmmm |
| AAAAAAAAA | mmmmmmmmm |
| AAAAAAAAA | mAmmAmmAm |
| AAAAAAAAA | mmmmmmmmm |
| AAAAAAAAA | mmmmmmmmm |
| AAAAAAAAA | mAmmAmmAm |
| AAAAAAAAA | mmmmmmmmm |

Said inter-cellular memories condition the behavior of said cellular automata. The users of said system change the contents of said inter-cellular memories to make said cellular automata act as desired.

### DETAILED DESCRIPTION OF THE INVENTION

### Embodiment 1

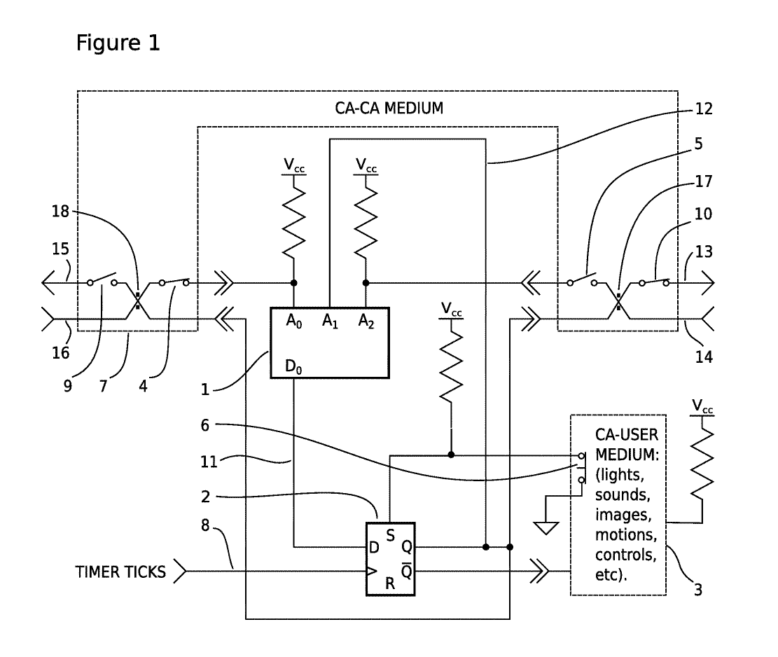

FIG. 1 presents a circuit diagram of a simplified cellular automaton (CA). It is assumed that on the left and out of the sight of FIG. 1, compatible (but not necessarily identical) CA has the output connected to the conductor denoted by reference numeral 16 and the input connected to the conductor denoted by reference numeral 15. In the same manner, on the right and out of the sight of FIG. 1, another compatible CA has the output connected to the conductor 14 and the input connected to the conductor 13.

Passing through the inter-cellular medium 7 (denoted by CA-CA), said conductors reverse their designations: Every input becomes an output of the CA depicted on FIG. 1, and every output becomes the input of said CA.

The rules of state transitions of a CA can be embodied in an infinite number of ways. Fortunately, they can be reduced to a truth table, which can be hardwired or loaded into a digital memory device.

The memory denoted by reference numeral 1 receives an address as the bits A₀, A₁, A₂ and produces one bit of data D₀. The address contains the bits, those the left (for A₀) and the right (for A₂) neighbor cellular automata (CAa) made available to said CA through the conductors 16 and 14, respectively. Address bit A₁ is said CA's own current state.

From the output D₀ of said memory, the next state of said CA passes through the conductor 11 to the flip-flop 2. As said flip-flop receives a timer tick 8, said next state becomes the current state. Said current state reaches the memory 1 as the address bit A₁. Through the inter-cellular medium 7 and the conductors 13 and 15, said current state appears on the memory units of said neighbor cellular automata as A₂ and A₀.

Said timer tick reaches every CA in the system and makes them assume their next states simultaneously. The delays introduced by the the flip-flop 2 and the memory 1 is presumed to be sufficient for this simplified solution to work.

The memory 1 of said CA stores the following Truth Table 1.

Truth Table 1

| A₀ | A₁ | A₂ | D₁ |
|---|---|---|---|
| 0 | 0 | 0 | 0 |
| 0 | 0 | 1 | 1 |
| 0 | 1 | 0 | 0 |
| 0 | 1 | 1 | 0 |
| 1 | 0 | 0 | 1 |
| 1 | 0 | 1 | 1 |
| 1 | 1 | 0 | 0 |
| 1 | 1 | 1 | 0 |

As a reminder: Flip-flop 2 stores the current state of said CA and passes it to pin A₁ of the memory 1. According to said Truth Table, If said current state is 1, the next state available from the pin D₀ of said memory may only be 0. Interpreting the state of 1 as “on” and the state of 0 as “off”, one can conclude that if said CA turns “on” for any reasons, it always turns itself “off” at the following timer tick.

According to said Truth Table, if said current state is 0 and any of the inputs, reaching pins A₀ and A₂ of said memory from the neighbor CAa, are 1, said next state must be 1.

If all the address bits A₀A₁A₂ of said memory are 0, said next state must be 0. If every CA in the system is in 0 state, the system is stable.

Momentary switch 6 forces said CA into the “on” state. The next depends on the inter-cellular memories. Said memories reside in the inter-cellular medium 7. Said memories are embodied in this embodiment as switches. The switches denoted by reference numerals 9 and 10 allow or block the propagation of the state of said CA to its left and right neighbors, respectively. Similarly, the switches 4 and 5 allow or block the propagation of the signals from the neighbors to said CA. Hence, the inter-cellular medium 7 provide 2 memories per every two neighbor CAa. From this point on, I will refer to said and functionally similar memories as inter-cellular memories.

If all the switches 4, 5, 9, 10 are open, and said CA is turned on, said Ca will fall back to state 0 without causing anything else. If all the switches are closed, the system will start oscillating in a checkerboard manner as below.

The following notation provides 3 numerals per every CA: the state of the left input switch (1 if closed, because a closed switch lets the signal through), the state of the CA and the state of the right input switch. A semicolon “:” marks the inter-cellular medium's centerline. On FIG. 1 said centerlines are denoted by reference numerals 18 and 17. They are nothing but delimiters helping to tell CAa from the neighbor CAa.

The right side of CA4 is connected to the left side of CA0, closing a loop. That's why there is no said inter-cellular medium's centerline on the left of CA0.

The following example describes a one-dimensional system of 5 CAa in action. All the switches are closed. On tick 3, the pattern starts repeating itself.

| Tick | CA0 | CA1 | CA2 | CA3 | CA4 | comment |
|---|---|---|---|---|---|---|
| 0 | 101: | 101: | 111: | 101: | 101: | CA2 was turned on |
| | | | | | | by hand. |
| 1 | 101: | 111: | 101: | 111: | 101: | CA2 off, CA1 and |
| | | | | | | CA3 on. |
| 2 | 111: | 101: | 111: | 101: | 111: | CA1, CA3 off, CA0, CA2, |
| | | | | | | CA4 on. |
| 3 | 101: | 111: | 101: | 111: | 101: | same as Tick 1 |

A simplest oscillator in this embodiment contains only 2 CAa. In the following example, CA1 and CA2 “bounce” the “on” state back and force, while CA0 and CA3 are staying “off” because their input switches are open.

| Tick | CA0 | CA1 | CA2 | CA3 | comment |
|---|---|---|---|---|---|
| 0 | 010: | 101: | 100: | 000: | CA0 was turned “on” by hand. |
| 1 | 000: | 111: | 100: | 000: | CA0 went “off” after turning on |
| | | | | | CA1. |
| 2 | 000: | 101: | 110: | 000: | CA1 went “off” after turning on |
| | | | | | CA2. |
| 3 | 000: | 111: | 100: | 000: | same as Tick 1. |

In the following example, a trail of closed switches to the right with all the left-bound switches open, facilitates so-called Mexican or metachronal wave. An “on” state appears to be endlessly traveling to the right. There could be several “on” states traveling together, as long as there is at least one CA in the “off” state between them. The action is synchronized by the timer ticks 8, but they do not tell CAa which state to assume.

| Tick | CA0 | CA1 | CA2 | CA3 | comment |
|---|---|---|---|---|---|
| 0 | 001: | 011: | 001: | 001: | CA1 was turned “on” by hand. |
| 1 | 001: | 001: | 011: | 001: | CA1 went “off” after turning on |
| | | | | | CA2. |
| 2 | 001: | 001: | 001: | 011: | CA2 went “off” after turning on |
| | | | | | CA3. |
| 1 | 011: | 001: | 001: | 001: | CA3 went “off” after turning on |
| | | | | | CA0. |
| 1 | 001: | 011: | 001: | 001: | Same as Tick 0. |

Some CAa states (likely, the “on” state) may some give sensory clues or indicia of their presence. Through the medium 3, CAa in such states may control anything what can be controlled by electricity. Said CAa can turn on lights, move things, backlight or project pictures, spray the water, etc. They could run a Rube Goldberg's machine or something more down-to earth. For example, if indicating elements, controlled by CAa, pop up, said Mexican waves will look like the waves on the water.

With all its simplicity, the system of this embodiment can run more complex patterns because connections established through the inter-cellular medium 7 are not based on proximity imposed by the medium 3. In other words, CAa, displaying their states next to each other, not necessarily cause each other to change said states.

Suppose that every CAa in the loop opens a circuit for an electric current, hence turning on a light emitting diode (LED) in the medium 3. If the chain of said CAa follows from CA0 to CA5 and back to CA0, if said LEDs are connected to the same number CAa, and if said LEDs are disposed to form a line, said LEDs turn on as follows.

| | |
|---|---|
| Tick | 01234567 |
| CA# | 01234501 . . . |
| LED# | 01234501 . . . |

Reversal of the order of the connections between said CAa and said LEDs makes said LEDs flash backwards.

| | |
|---|---|
| Tick | 01234567 . . . |
| CA# | 01234501 . . . |
| LED# | 54321054 . . . |

A straight loop of 9 CAa can drive a two-steps-forward-one-step-back spatiotemporal pattern on 3 LEDs. In the following circuit, every LED can be turned on by any 1 out of 3 CAa at a time. With open collector outputs and stacking connectors, CAa 0, 5, 7 can turn on LED 0, CAa 1, 3, 8 can turn on LED1, CAa 2, 4, 6 can turn on LED2.

| | | | |
|---|---|---|---|
| CA# | 012 | Tick | 0123456789 . . . |
| | 534 | CA# | 012345678012 . . . |
| | 786 | LED# | 012120201012 . . . |
| LED# | 023 | | |

In the following example, every CA controls several LEDs. The numerals in the array tell the number of the CA controlling these LEDs. The smallest 4-LEDs square in the middle flashes on tick 0, the next bigger square flashes on tick 1, etc. The resulting wave “moves” from the center out.

The squares have 4, 12, 20 and 28 LEDs, which is physically challenging, but there are many ways to broadcast the changes. By this illustrative proof-of-concept embodiment, I only wanted to demonstrate that the causality driving apparently complex spatiotemporal pattern may be much simpler than it seems.

| | | | |
|---|---|---|---|
| Tick | 012345 . . . | LEDS: | 33333333 |
| CA# | 012301 . . . | | 32222223 |
| | | | 32111123 |
| | | | 32100123 |
| | | | 32100123 |
| | | | 32111123 |
| | | | 32222223 |
| | | | 33333333 |

### Embodiment 2

Embodiment 2 was written entirely in standard computer-independent language ECMAScript (ECMA-262, ISO/IEC 16262). At the time of writing, the demo software could be executed on any computer supporting a current desktop version of Internet Explorer, Google Chrome or Mozilla Firefox web browsers.

To review this embodiment, please use any of said web browsers to open the file “embodiment2.html”. Said file must be opened in the directory containing the files submitted with this patent application. The “.txt” endings must be removed and “_” must be replaced with “.”. The file “help.html” in the same directory launches the interactive manual. This demo software contains 20 networks producing various spatiotemporal patterns. Like Embodiment 1, Embodiment 2 is not preferred or definitive in any sense.

In this embodiment, the cellular automata (CAa), together with inter-cellular memory, reside in said computer's memory and use said computer's video monitor. A system of this embodiment appears to the users as a rectangle tessellated with square-shaped tiles. Said CAa indicate their “on” states filling said tiles with colors. In doing so, they create spatiotemporal patterns in 2 dimensions. Due to the limitations of ECMAScript, no other indicia are available. Embodiment 2 can accommodate different kinds of CAa.

In this embodiment, the inter-cellular medium, functionally similar to CA-CA medium 7 in Embodiment 1, has a graphical user interface (GUI). Said GUI is combined with CA-to-USER medium's GUI. Said system has a plurality of modes, in which CAa's states and parameters are also displayed in said tiles for design and debugging purposes.

Said system is fully user programmable. It was designed to encourage the users to learn computer programming in order to do more.

To transcribe CAa and the contents of inter-cellular memories, I enhanced the ASCII notation from Embodiment 1 as follows.

~~~:~~~:
~B1:~R~:
~~~:~1~:
−−−+−−−+
~1~:~~~:
~Y~:1G~:
~~~:~~~:
−−−+−−−+

The symbols “−”, “:” and “+” are the centerline markers delimiting the cells. Every said cell occupies a tile and serves a single cellular automaton (CA). Every said cell is further divided 3×3 into 9 elements. In the above example, every element is represented with a non-delimiting character: ˜, B, R, Y, G, 1.

The rectangular media in this embodiment is a 2-dimensional depiction of a torus. The right side is contiguous to the left side, the top side is contiguous to the bottom side, the top-right corner is contiguous to the bottom-left corner, and the top-left corner is contiguous to the bottom-right corner. The horizontal delimiter “−” marks only the bottom boundary, the vertical delimiter “:” marks only the right boundary, and the corner delimiter “+” marks only the bottom right corner of the tiles. The delimiters are not parts of a cell, and said delimiters are not used in GUI.

In this embodiment, stock CAa have 3 states: 0 (“off”), 1 (“wait”) and 2 (“on”). The “wait” state is optional, and there can be more states. The “on” and “wait” states have additional information (state variables). All the state transitions must seem to occur at a timer tick.

The central element of every cell contains a letter encoding the color assigned to said cell's CA: N or n for neutral gray, B for blue, G for green. O for orange, R for red, Y for yellow. In GUI, the system of this embodiment fills the whole tile with said color only to indicate that said CA is in the “on” state. Said central element can display the color for design and debugging purposes.

The peripheral elements of every cell form a corolla of 8 petals. Said corolla is the part of the inter-cellular medium (formerly known as CA-to-CA medium) servicing said CA. The symbols in said petals reflect the contents of the inter-cellular memories, residing in said medium. In this embodiment, said inter-cellular memories may further comprise pluralities of ECMAScript data and objects, said pluralities not shown in GUI.

For every CA, said inter-cellular medium provide one inter-cellular memory per every relative direction: top-left, top, top-right, right, bottom-right, bottom, bottom-left and left. Cardinal and intercardinal directions NW, N, NE, E, SE, S, SW may be used in the relative sense. If a neighbor B is to the Northeast from A, then A is to the Southwest from B. Since both A and B have 1 inter-celluar memory, there are 2 inter-cellular memories between them and every two neighbor CAa. Unlike in Embodiment 1, the inter-cellular memories in a cell serve the outputs.

In this embodiment, the content of an inter-cellular memory can be a tilde (“˜”), or a numeral from 0 to 9. The bigger numbers can be set through programming. A tilde means that the corresponding direction is impassable.

A new system in this embodiment starts with every CAa colored gray and every inter-cellular memory storing a tilde. Designers dispose the colors and the numbers, opening the communication channels, symbolized by the petals, and timing said channels. Usually most of said channels remain closed. This prompted me to refer to configured systems as networks and liken said networks to social networks (particularly, Twitter).

In Embodiment 2, all CAa begin their lives in the “off” state, and they do not change said state on their own. GUI allows to force any CA “on” with a mouse click.

In this embodiment, a CA entering the “on” state prompts its corolla to notify every allowed neighbor. The neighbors behind the tildes are forbidden. Every notification comprises the number in the inter-cellular memory serving said direction. This strategy of influence may be referred to as “push”. The “pull” embodiment, wherein network designers subscribe CAa to their neighbors' notifications, does exist and yields the same spatiotemporal patterns.

In this embodiment, petals are the instances of the class link( ). Said class has the method kick( ), which, like everything else in ECMAScript, is a function. When “kicked” and if allowed, the petal may calls the neighbor CA's method set(t), wherein t is the wait time in this petal's inter-cellular memory.

Upon being notified, a stock CA reacts depending on its own state. If said state is 2 (or “on”), any said notification will be ignored. If said state is 0 (or “off”), said CA enters the state 1 (or “wait”) and memorizes said number t as a parameter of said state. Said parameter becomes the time to wait. CA decrements said parameter on every timer tick and enters the state 2 (“on”) when said time to wait is 0.

In this specification, any analogies between CAa and living organisms as being distinguishable from each other, influencing each other or being capable to react are only metaphors. Depending on how to draw a circuit or which programming paradigm to use, designs of the systems, comprising CAa, may obscure said metaphors and make them difficult to apply. Similarly, additional functionality may hide a cellular automata's core. However, the users of this invention must be enabled to understand that color spots and other possible indicia mean objects, that said indicia appear and/or disappear in accordance with some common rules, even if there are several sets of said rules, and that said indicia influence the other indicia, making them appear and/or disappear.

In this embodiment, the glow time is a global parameter common to every CA. Individually, it can only be set through programming. Once a CA has entered the state 2 (“on”), it memorizes the glow time as a parameter of this state and starts decrementing it with every timer tick. When said glow time becomes 0, said CA enters the “off” state.

The default value of the glow time is 1 timer tick. If not otherwise specified, the glow time in the following examples is assumed to be equal to 1 timer tick.

If the glow time is set to 1, and the following network was started from B (blue), said network will blink BRYGB . . . until stopped.

~~~:~~~:
~B1:~R~:
~~~:1~~:
−−−+−−−+
~~~:1~~:
~Y1:~G~:
~~~:~~~:
−−−+−−−+

If the glow time is set to infinity, oscillations become impossible. Once CAa go “on”, they stay “on”. The network “paints” the static pattern and stops. With infinitely long glow time, networks can demonstrate how to build the patterns, or lead the builders.

Since oscillations are loops, any network under infinitely big glow time will behave as if it was a tree or a forest (although it's an oriented graph). For young children, parallelism must be carefully avoided. They must receive instructions step by step and one step at a time. To serialize the execution, designers must plan ahead and leave behind the “dormant buds”: CAa with the long wait times.

The network below fills the middle 2×2 square, then bulds a “spinner”. Said spinner turns into a cross, said cross further disappears in a 4×4 square. Assuming that the CA in the top-left corner is at (0,0), the pattern must be started from turning “on” the CA at (1,1).

The first 4 CAa (ticks 0-3) are neighbors, as well as the last 4 CAa (ticks 13-15). The last 4 CAa, in fact, form another 2×2 square. However, the CAa going “on” on ticks 4-7 and 8-11 can only participate because they receive 4 ticks long wait times.

| | | | | |
|---|---|---|---|---|
| ~~~:~~~:~~~:~1~: | Tick 0 | Tick 1 | Tick 2 | Tick 3 |
| 1B~:~B4:~B4:~B~: | nnnn | nnnn | nnnn | nnnn |
| ~~~:~~~:~~~:~~~: | nBnn | nBBn | nBBn | nBBn |
| −−−+−−−+−−−+−−−+ | nnnn | nnnn | nnBn | nBBn |
| ~~~:~4~:~~~:~~~: | nnnn | nnnn | nnnn | nnnn |
| ~B~:~B1:~B4:~B~: | Tick 4 | Tick 5 | Tick 6 | Tick 7 |
| ~~~:~~~:~1~:~4~: | nBnn | nBnn | nBnn | nBnn |
| −−−+−−−+−−−+−−−+ | nBBn | nBBB | nBBB | nBBB |
| ~4~:~1~:~~~:~~~: | nBBn | nBBn | nBBn | BBBn |
| ~B~:4B~:1B~:~B~: | nnnn | nnnn | nnBn | nnBn |
| ~~~:~~~:~4~:~~~: | Tick 8 | Tick 9 | Tick 10 | Tick 11 |
| −−−+−−−+−−−+−−−+ | nBBn | nBBn | nBBn | nBBn |
| ~~~:~~~:~~~:~~~: | nBBB | nBBB | nBBB | BBBB |
| ~B~:~B~:4B~:~B1: | BBBn | BBBB | BBBB | BBBB |
| ~1~:~~~:~~~:~~~: | nnBn | nnBn | nBBn | nBBn |
| −−−+−−−+−−−+−−−+ | Tick 12 | Tick 13 | Tick 14 | Tick 15 |
| | nBBB | nBBB | nBBB | BBBB |
| | BBBB | BBBB | BBBB | BBBB |
| | BBBB | BBBB | BBBB | BBBB |
| | nBBn | nBBB | BBBB | BBBB |

In this embodiment, the wait time can be 0. Notifications carrying a wait time of 0 will be referred to as instant messages. Upon receiving an instant message, the CA goes “on” and notifies its neighbors immediately. If an inter-cellular memory in the direction of notification has 0 wait time too, and the neighbor in said direction is not in “on” state, said neighbor goes “on” and notifies its neighbors immediately. The CAa in the “on” state do not react to any notifications.

The 2×2 squares of CAa in the following example change their states at once. The oscillation starts in top-left corner. The corners turn “on” each other with 1 tick delay. The neutral gray color, which CAa assume then they are “off”, is denoted by the small letter n to make the “on” colors more prominent.

| | | | | |
|---|---|---|---|---|
| ~~~:~~~:~1~: | Tick 0 | Tick 1 | Tick 2 | Tick 3 |
| 1R0:~Y~:0R~: | RYn | nYR | nnn | nnn |
| ~0~:~0~:~0~: | YYn | nYY | nYY | YYn |
| −−−+−−−+−−−+ | nnn | nnn | nYR | RYn |
| ~~~:~~~:~~~: | | | | |
| ~Y0:~Y~:0Y~: | | | | |
| ~~~:~~~:~~~: | | | | |
| −−−+−−−+−−−+ | | | | |
| ~0~:~0~:~0~: | | | | |
| ~R0:~Y~:0R1: | | | | |
| ~1~:~~~:~~~: | | | | |
| −−−+−−−+−−−+ | | | | |

A simplest oscillator in this embodiment consists of two CAa. Instant messages can stop oscillations. In the following network, a mouse click on the green (G) CA starts an oscillation of the yellow CAa. A mouse click on the red (R) CA stops said oscillation.

‘~~~:~~~:’+
‘~Y1:1Y~:’+
‘~~~:~~~:’+
‘−−−+−−−+’+
‘~1~:00~:’+
‘~G~:~R~:’+
‘~~~:~~~:’+
‘−−−+−−−+’+

The oscillators can use the wait times longer than 1. The following network has a 1:2 oscillator and produces 4 different patterns:

| | | |
|---|---|---|
| ~~~:~~~: | Ticks: | 123456789 |
| ~B1:2Y~: | Colors: | BnnBnnBnn |
| ~0~:01~: | | nYnnYnnYn |
| −−−+−−−+ | | RRnRRnRRn |
| ~~~:~~~: | | nnGnnGnnG |
| ~R~:~G~: | | |
| ~~~:~~~: | | |
| −−−+−−−+ | | |

A system of this embodiment is a spatiotemporal controller. The following networks demonstrates two strategies for managing an imaginary irrigation systems. I am using only single-digit numbers for understandability.

| Irrigation controller 1 | Irrigation controller 2 |
|---|---|
| ~0~:~0~:~0~:~0~:~0~:~0~: | ~2~:~1~:~3~:~5~:~2~:~1~: |
| ~Y0:~Y0:~Y0:~Y5:~Y0:~Y9: | ~Y~:~Y~:~Y~:~Y~:~Y~:~Y~: |
| ~~~:~~~:~~~:~~~:~~~:~~~: | ~~~:~~~:~~~:~~~:~~~:~~~:~~~: |
| −−−+−−−+−−−+−−−+−−−+−−−+ | −−−+−−−+−−−+−−−+−−−+−−−+ |
| ~~~:~~~:~~~:~~~:~~~:~~~: | ~0~:~0~:~0~:~0~:~0~:~0~: |
| ~N~:~N~:~N~:~B~:~N~:~N~ | 0G0:0G0:0G0:0G0:0G0:0G0: |
| ~~~:~~~:~~~:~0~:~~~:~~~: | ~~~:~~~:~~~:~~~:~~~:~~~: |
| −−−+−−−+−−−+−−−+−−−+−−−+ | −−−+−−−+−−−+−−−+−−−+−−−+ |
| ~~~:~~~:~~~:~1~:~~~:~~~: | ~~~:~~~:~~~:~~~:~~~:~~~: |
| ~B~:~N~:~N~:~B~:~B~:~N~: | ~B~:~N~:~N~:~B~:~N~:~N~: |
| ~0~:~~~:~~~:~0~:~0~:~~~: | ~0~:~~~:~~~:~0~:~~~:~~~: |
| −−−+−−−+−−−+−−−+−−−+−−−+ | −−−+−−−+−−−+−−−+−−−+−−−+ |
| ~1~:~~~:~~~:~1~:~1~:~~~: | ~1~:~~~:~~~:~1~:~~~:~~~: |
| ~B~:~N~:~B~:~B~:~B~:~N~: | ~B~:~N~:~B~:~B~:~B~:~N~: |
| ~0~:~~~:~0~:~0~:~0~:~~~: | ~0~:~~~:~0~:~0~:~0~:~~~: |
| −−−+−−−+−−−+−−−+−−−+−−−+ | −−−+−−−+−−−+−−−+−−−+−−−+ |
| ~1~:~~~:~1~:~1~:~1~:~~~: | ~1~:~~~:~1~:~1~:~1~:~~~: |
| ~B~:~B~:~B~:~B~:~B~:~B~: | ~B~:~B~:~B~:~B~:~B~:~B~: |
| ~0~:~0~:~0~:~0~:~0~:~0~: | ~0~:~0~:~0~:~0~:~0~:~0~: |
| −−−+−−−+−−−+−−−+−−−+−−−+ | −−−+−−−+−−−+−−−+−−−+−−−+ |
| ~1~:~1~:~1~:~1~:~1~:~1~: | ~1~:~1~:~1~:~1~:~1~:~1~: |
| ~B~:~B~:~B~:~B~:~B~:~B~: | ~B~:~B~:~B~:~B~:~B~:~B~: |
| ~~~:~~~:~~~:~~~:~~~:~~~: | ~4~:~2~:~3~:~6~:~4~:~2~: |
| −−−+−−−+−−−+−−−+−−−+−−−+ | −−−+−−−+−−−+−−−+−−−+−−−+ |

The bottom blue CAa in said networks control the valves. The stacks of blue CAa on top of said bottom CAa keep said bottom CAa “on”. Every CA on a stack extends the watering time by 1.

In the beginning of the watering cycle, the yellow CAa at the top of the network sends the notifications turning “on” said bottom blue CAa. Consequently, the “on” state propagates through every stack. As the top CA of the stack turns “off”, the whole stack turns “off” and stays “off” until the next turning “on” notification from the yellow CA.

The yellow CAa start the cycles of the blue CAa. The irrigation controller 1 is driven by a single loop, in which the groups of the stations may turn “on” simultaneously. The last CA in such a group sends a notification to the next CA telling it when to turn “on”.

The irrigation controller 2 has a bar of green CAa. Said green CAa turn “on” simultaneously, turning “on” every yellow CA. Said yellow CA notifies a bottom blue CA, telling it when to turn “on”. As said bottom blue CA turns “on”, it sends a notification back to said blue CA telling it when to turn “on”.

While being more complex than Embodiment 1, Embodiment 2 can be re-embodied as an electronic device by an ordinary skilled practitioner, or said embodiment can be considered a computer simulation of a hypothetical electronic device. In computer simulation, an area in computer memory must be allocated for every information storage device or unit (flip-flop, memory, switches, counter, etc).

Computer data do not propagate through conductors like electric signals. Said data must be copied from one place in said memory to another by mean of processor instructions. Hence, the inter-cellular memories must use some computer code to function.

There are instructions to add (subtract) the values stored in said memory and to compare said values with some other values. Depending on the result of the comparison, processor can choose one of two chains of instruction to execute, hereby acting as a conditioned switch. Filling an area on computer monitor with a color is not conceptually different from turning on a LED, except a monitor provides more flexibility.

### Beyond Embodiment 2

Embodiment 2 is an early proof-of-concept made for distribution over the Internet. Said embodiment was derived from my experimental software: It works as intended, but it's not an example of good programming. The design of said embodiment was limited by the capabilities of web browsers and ECMAScript. Another reason why many improvements were not implemented: I wanted to keep the user interface as flat and simple as possible, avoiding context menus, pop-up forms and other encumbrances.

The only indicium of the “on” state of a CA in Embodiment 2, is the color of said CA filling the tile of said CA. In this invention, CAa are not limited to any indicium of their states. In a fully operational programming system, said states may be indicated with anything that computers can produce or control, including, but not limited to, colors, shapes, sounds, images, numbers, letters, texts, external devices, including moving devices, and combinations thereof (like, for example, an image and a sound).

The methods to produce indicia of CAa's states are not the matter of this invention. Said methods are widely different on different computing platforms. There are no universally accepted methods to project an image on the computer monitor's screen or to make a sound. There are many methods specific to certain combinations of hardware and software, known to the practitioners of the art and described in the technical documentation.

In ECMAScript, an image contained in the file “apple.svg” can be displayed inside a cell, said cell represented with HTML DIV element, in the following way.

//Create a 2×2 system
init(2,2);
//Make a bottom-right cell transparent (the color number 8)
cells[1][1].clr.set(8);
//Display the image found in the file named “apple.svg”
//at the center of said cell
cells[1][1].view.style.background
=‘black url(“apple.svg”) no-repeat center center’;

In Embodiment 2, CAa influence, and indirectly cause each other to assume the “on” state. For the user and operator of the system, it is supposed to appear that the CAa pass their “on” states to their neighbors, making said neighbors show their colors. Embodiment 2 can be easily modified to make an impression that, along with said “on” states, CAa pass their indicia to said CAa's neighbors. Parameters of the states—for example, wait time or glow time—can be passed along too.

An indicia passing from CAa to its neighbors can produce, for example, the impression of motion, or said indicia can make the changes of the states audible in the same way. The inter-cellular memories can facilitate passing said indicia and said parameters, providing, for example, the user-editable information about what, where, in what direction and when must be passed, and, possibly, altered (for example, an image can be rotated, a number can be incremented).

An indicium passing from CA to CA can be an ordered plurality of indicia. Said ordered plurality may be named and used differently in different computer languages and computing platforms. Commonly, said ordered plurality allows to store a plurality of indicia, selecting one indicium at a time. Said ordered plurality must further allow to access the next and the previous undicia in relation to the selected indicium. Said ordered plurality must further allow to recognize that an accessible indicia is the first or the last.

The following code creates a 2×2 system and the ordered plurality named “images”. The members of said ordered plurality are the character strings, representing the names of the files “elephant.svg” and “apple.svg”. The name “elephant.svg” is the first member of said ordered plurality. Said name can be obtained as images [0]. Respectively, the name “apple.svg” can be obtained as images [1]. The following code displays the image from the file “elephant.svg”.

```
init(2,2);
Window.images=new Array(2);
Window.images[0]=‘elephant.svg’;
Window.images[1]=‘apple.svg’;
cells[1][1].clr.set(8);
cells[1][1].view.style.
  background=‘black url(‘+Window.images[0]+
  ’) no-repeat center center’;
```

Then, the image from the file “apple.svg” can be displayed as follows.

```
cells[1][1].view.style.
  background=‘black url(‘+Window.images[1]+
  ’) no-repeat center center’;
```

The code can be executed from the text editor of Embodiment 2 (the button edit TXT).

An ordered plurality provides not just an indicia, but the sequence of them. Said ordered plurality allows, for example, to display text by letters or words, play music and/or animations.

Once any of the neutral gray CAa in the following network is “on”, the “on” state will start “hoping” around. Every time a gray CA will go “on”, it will send an instant message to the central CA colored green. The green CA will be receiving such instant messages on every timer tick. For the user of the system, said green CA will appear to stay “on”. A standing animation in the center of such a network may (and must) be run by the inter-cellular memories only.

~~~:~~~:~~~:
~N1:~N1:~N~:
~~0:~0~:01~:
−−−+−−−+−−−+
~1~:~~~:~~~:
~N0:~G~:0N~:
~~~:~~~:~1~:
−−−+−−−+−−−+
~10:~0~:0~~:
~N~:1N~:1N~:
~~~:~~~:~~~:
−−−+−−−+−−−+

In Embodiment 2, many tempting improvements can be implemented through additional CAa without changing them in any way. To simulate the “hesitation step” below, it seems to be necessary to keep and resend the notifications, which could not be delivered because the recipient was in the “on” state.

The row of gray helper CAa in the following network allows to avoid such a necessity. The color makes their activity invisible.

The purpose of the green CA is to start the pattern properly. The chart on the right shows how the line of the blue CAa changes from tick to tick.

| ~~~:~~~:~~~:~~~:~~~:~~~: | Tick# | |
|---|---|---|
| ~G~:~N~:~N~:~N~:~N~:~N~: | 0 | nBnnnn |
| ~10:~~~:~~~:~~~:~~~:~~~: | 1 | BBnnnn |
| −−−+−−−+−−−+−−−+−−−+−−−+ | 2 | BnBnnn |
| ~~~:~~~:~~~:~~~:~~~:~~~: | 3 | nBBnnn |
| ~B~:~B~:~B~:~B~:~B~:~B~: | 4 | nBnBnn |
| ~1~:~1~:~1~:~1~:~1~:~1~: | 5 | nnBBnn |
| −−−+−−−+−−−+−−−+−−−+−−−+ | 6 | nnBnBn |
| ~01:~01:~01:~01:~01:~01: | 7 | nnnBBn |
| ~N~:~N~:~N~:~N~:~N~:~N~: | 8 | nnnBnB |
| ~~~:~~~:~~~:~~~:~~~:~~~: | 9 | nnnnBB |
| −−−+−−−+−−−+−−−+−−−+−−−+ | 10 | BnnnBn |
| | 11 | BnnnnB |
| | 12 | nBnnnB |
| | 13 | BBnnnn |

Like other CAa, the system of this embodiment can be expanded to 3 dimensions. A 3-D cell would have 26 neighbors and 26 petals. The GUI may show the cells relatively small, enabling the user to “travel” through the space between said cells. It is possible to use some non-rectangular tessellations too.

Currently, every cell in this embodiment has only 8 neighbors (so-called Moore neighborhood). Only one-to-one relation between the CAa and the cells is currently implemented. Connecting more than 8 neighbors and establishing complex relations between said CA and the tiles can be done through programming. However, implementing this functionality in a GUI is possible. An obvious way to do it is to layer the inter-cellular medium like a multilayer circuit board, which allows potentially unlimited connectivity.

In a multilayer inter-cellular medium, the line of gray helper CAa from the network above can be hidden beneath the blue line. Another way to hide the helper CAa, is to frame every vertical pair of blue and gray cells as a single “super” cell, said “super” cell using the left petal of the blue cell as said “super” cell's left petal, and the top-right petal of the gray cell as said “super” cell's right petal.

The colors of the CAa comprising said super cell can be selected from the available colors or mixed. If the color of the helper CAa is red, the color of both CAa turned “on” is magenta (M), and the chart will look as follows.

| ~~~:~~~:~~~:~~~:~~~:~~~: | Tick# | |
|---|---|---|
| ~G~:~N~:~N~:~N~:~N~:~N~: | 0 | nBnnnn |
| ~10:~~~:~~~:~~~:~~~:~~~: | 1 | BMnnnn |
| −−−+−−−+−−−+−−−+−−−+−−−+ | 2 | MnBnnn |
| ~~~:~~~:~~~:~~~:~~~:~~~: | 3 | nBMnnn |
| ~B~:~B~:~B~:~B~:~B~:~B~: | 4 | nMnBnn |
| ~1~:~1~:~1~:~1~:~1~:~1~: | 5 | nnBMnn |
| −−−+−−−+−−−+−−−+−−−+−−−+ | 6 | nnMnBn |
| ~01:~01:~01:~01:~01:~01: | 7 | nnnBMn |
| ~R~:~R~:~R~:~R~:~R~:~R~: | 8 | nnnMnB |
| ~~~:~~~:~~~:~~~:~~~:~~~: | 9 | nnnnBM |
| −−−+−−−+−−−+−−−+−−−+−−−+ | 10 | BnnnMn |
| | 11 | MnnnnB |
| | 12 | nBnnnM |
| | 13 | BMnnnn |

In Embodiment 2, CAa may send instant messages (or 0 wait time notifications), including those incurred by the user's mouse clicks. A plurality of CAa, instantly messaging each other in two directions, replicate each other: Every one of them gets the others' tiles to control and to be controlled from.

~~~:~~~:~~~:~~~:~~~:~~~:~~~:~~~:~~~:~~~:
~Y~:~Y~:~Y~:~Y~:~Y~:~Y~:~Y~:~Y~:~Y~:~Y~:
~0~:~0~:~0~:~0~:~0~:~0~:~0~:~0~:~0~:~0~:
−−−+−−−+−−−+−−−+−−−+−−−+−−−+−−−+−−−+−−−+
~~~:~~~:~~~:~~~:~~~:~~~:~~~:~~~:~~~:~~~:
~N0:~N0:~N0:~N0:~N0:~N0:~N0:~N0:~N0:~N0:
~~~:~~~:~~~:~~~:~~~:~0~:~~~:~~~:~~~:~~~:
−−−+−−−+−−−+−−−+−−−+−−−+−−−+−−−+−−−+−−−+
~~~:~~~:~~~:~~~:~~~:~~~:~~~:~~~:~~~:~~~:
~Y~:~Y~:~Y~:~Y~:~Y~:~R~:~Y~:~Y~:~Y~:~Y~:
~~~:~~~:~~~:~~~:~~~:~0~:~~~:~~~:~~~:~~~:
−−−+−−−+−−−+−−−+−−−+−−−+−−−+−−−+−−−+−−−+
~~~:~~~:~~~:~~~:~~~:~~~:~~~:~~~:~~~:~~~:
~N~:0N~:0N~:0N~:0N~:0N0:~N0:~N0:~N0:~N~:
~0~:~0~:~0~:~0~:~0~:~0~:~0~:~0~:~0~:~0~:
−−−+−−−+−−−+−−−+−−−+−−−+−−−+−−−+−−−+−−−+
~~~:~~~:~~~:~~~:~~~:~~~:~~~:~~~:~~~:~~~:
~B~:~B~:~B~:~B~:~B~:~B~:~B~:~B~:~B~:~B~:
~~~:~~~:~~~:~~~:~~~:~~~:~~~:~~~:~~~:~~~:
−−−+−−−+−−−+−−−+−−−+−−−+−−−+−−−+−−−+−−−+

Instant messages can connect one CAa to many CAa or many CAa to one. In the network above, any yellow CA can turn “on” the red CA and all the blue CAa at once. The instant messaging may be also used to gain additional connectivity through a multilayer inter-cellular medium.

A petal in Embodiment 2 symbolizes both input and output connectors, wherein inter-cellular memories serve the outputs only. Connecting a petal to an arbitrary petal may require to disconnect both of them from their counterparts in Moore neighborhood, and reroute the notifications. In Embodiment 1, this would take unplugging a conductor and plugging in elsewhere. In Embodiment 2, CAa and inter-cellular memories are organized as two-dimensional ordered pluralities (Arrays). To find their counterparts, the code in said CAa and said inter-cellular memories calculate the indices to said arrays. The exact method of calculation is located in said method kick( ) of said object link( ) To accommodate arbitrary connections, the index arithmetic may, for example, be enhanced with variables, said variables directly pointing to the destinations of the petals, said variables being the parts of said petals' inter-cellular memories. During the initialization of a newly created system, said variables can be assigned the destinations according to the Moore neighborhood. Then, said destinations can be reassigned. The changes would be localized in the inter-cellular (CA-to-CA) medium.

To break out of the 8-cells Moore neighborhood and start using any number of arbitrary connections, CAa need more petals. I will refer to the ninth and the higher order petals as “hyper” petals. “Hyper” petals can symbolize connectors or soldering pads, CAa must be made aware of them and include them in the notification routine. One possible method to make said CAa aware of any number of petals is to enhance said CAa with the ordered pluralities of the petals, and access the instances of the objects link( ) through said ordered plurality. In case of ECMAScript such an ordered plurality can be an Array, and Arrays are expandable. Hence, the changes must affect both the CAa and the inter-cellular medium.

A freehand connection may originate in any petal and pass notifications to influence any CA. The improvements proposed this far can enable CAa and their inter-cellular memories to support freehand connections because said inter-cellular memories can point at the CAa to be influenced with notifications.

Splitting and joining connections incurs a deeper change: connector itself must be represented with the data and code. The mathematical model is referred to as a graph, and it's very well known. To selectively and/or collectively serve the outgoing notifications and condition the reactions to the incoming notifications, the inter-cellular medium must furnish 2 inter-cellular memories for every CAa.

I have reviewed several possible improvements of the connectivity of the cells in Embodiment 2, including “super” cells, multilayer media, “hyper” petals and freehand connections. Said improvements are available through programming. To make said improvements available to the users, said improvements must be represented in GUI. Said GUI depends on computing platform, and I don't believe creating it would be an out of ordinary job.

Discussing Embodiment 2, I was avoiding specifying multilayer media because the design of said media affects the user interface and depends on it. Here I am going to specify one possible (and, possibly, the simplest) solution. A multilayer medium can be the stack of the regular media, said media are aligned on top of each other and have one and the same size. Said stack can grow up and down to any height or depth. Every CA in said stack has two extra petals facing up and down respectively, said petals link said CA with the upper CA and the lower CA if they present. Hence, CAa have 10 neighbors, 10 petals and an extra dimension, even if incomplete. I will refer to such 10-neighbors medium as a decimal medium. It's a cross between Moore neighborhood and von Neumann neighborhood.

All said improvements are complementary. A “super” cells may be a part of a multilayer medium. Said “super” cell may comprise a hyper petal and another “super” cell, said “super” cell further comprising a multilayer medium with a freehand connection, etc.

This patent application do not claim or assume any spatial organization or organizations of CAa and inter-cellular memories. Even the limited functionality of Embodiment 2 supports a plurality of spatial organizations, including graphs.

To design and debug the networks and to run the patterns, a system of Embodiment 2 has a plurality of controls. Said controls produce events and/or supply the data to the software. For example: a mouse click may selects a color value, the next mouse click may assigns this value to a CA.

A HTML selector sets the “mode” of the system. In the “GO!” mode, said system can simulate a network of configured CAa and inter-cellular memories (from the user's standpoint, this means running a pattern). Simulation is driven by the timer ticks from the browser. Said system can also be paused for setting up or debugging, or it can be stopped to allow the user to design the network and/or to fix the errors. In paused and stopped modes, the browser's timer ticks are disabled. When paused, the system has the TICK button. Said button converts the mouse clicks to the timer ticks. Clicking on said button, the designer can advance the simulation time by hand.

Internally, Embodiment 2 has everything to control design and simulation of said networks from said CAa and said inter-cellular memories, while said networks are being designed or simulated. In other words, the elements of the networks can change said networks (as well as the other networks). Likewise, the simulated behavior of said elements can control it's own simulation (as well as the other simulations), while being simulated.

The kind of computing, wherein the programs do what the users were supposed to do, is known as scripting. Embodiment 2 supports scripting by design, because it is written in a scripting language. Said embodiment also supports synchronous scripting.

For example, a user of Embodiment 2 can load a saved network, start simulation and watch the pattern unfolding. When said pattern is over, said user can stop simulation, load a followup pattern and start simulation to watch it. Such succession of related networks can be synchronously scripted: The network-changing script will be started whenever the network meets a predermined condition. This can only happen synchronously, following a timer tick.

The simplest kind of said condition is a state transitions in a predetermined CA. To facilitate synchronous scripting, CAa in Embodiment 2 perform function calls like, for example, onOn( ), during their state changing procedures. If said function is not defined, the call is skipped. If a function is defined, it is called.

Scripting between at least two independently controlled and simulated media I will refer to as cross-scripting. A system able to support at least two independently controlled and simulated media I will refer to as a multimedia system.

For example, if timer ticks are served from a CA to the different media, the time in said media can locally stop, leaving the structures of ephemeral states unchanging like durable things. A loop of cells, which normally passes around an “on” state without stopping, may be used to count the ticks. Two such loops timing one another may act as two meshing gears.

Building the network in a hypothetical multimedia system shown below, I assumed that the inter-cellular memories may store a symbol “tick” (“<<” symbolize a connector). When a CA sends a notification, said symbol requires to convert said notification to a timer tick. Technically, a timer tick is just a different function call. Said call affects all the CAa in a medium, hence said call is easier to understand if said CAa belong to a different medium. Timing a medium from CAa inside said medium is possible, but slightly more complicated. For example, with the glow time equal to 1 tick, a CA of Embodiment 2 need 2 ticks per every turn “on” event it produces.

Three columns of cells in said network are three separate media. Medium 0 receives the time from the system. Medium 1 is timed from Medium 0. Medium 2 is timed from Medium 1.

Said media produce the patterns of bar indicators. Said indicators display the numeric values from 0 (only the invisible gray cell at the bottom is “on”) to 9 (all the blue cells are “on”).

In the beginning, the 3 bottom gray CAa must be turned “on” one by one from right to left (the order is important). Driven by the browser's timer ticks, Medium 0 “fills up” with the blue tiles. As the top CA expires, every blue CA below it go “off” at once too. At the same time, the bottom gray CA turns “on” again. While turning “on”, said CA sends a notification to the left and to the top.

The notification directed to the left becomes a timer tick served to Medium 1. Said medium adds up one blue tile every time Medium 0 cleans up. As the number of the “on” tiles in Medium 1 reaches 9, said media cleans up and times Media 2. Hence, the whole network produces the pattern of a 3-digit decimal counter.

| Medium 2 | Medium 1 | Medium 0 |
|---|---|---|
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~0~: | ~0~: | ~0~: |
| −−−+ | −−−+ | −−−+ |
| ~1~: | ~1~: | ~1~: |
| ~B~: | ~B~: | ~B~: |
| ~~~: | ~~~: | ~~~: |
| −−−+ | −−−+ | −−−+ |
| ~1~: | ~1~: | ~1~: |
| ~N~: | <<tick0N~: | <<tick0N~: |
| ~~~: | ~~~: | ~~~: |
| −−−+ | −−−+ | −−−+ |

One way to make Embodiment 2 a multimedia system is to launch several fully functional instances of the system of said Embodiment, Said instances can be launched in the same or from the same browser's window. A simple coordinating software with GUI will still be needed.

Another approach is to strip parts of the medium of some privileges or functionality. In the example above, there can be 3 ordered pluralities of CAa: one of said pluralities being served by the browser's ticks, the other two by the same simulation function tock( ) called from the bottom gray CAa. The function tock( ) has to be modified to accept the reference to an ordered plurality to be served. In Embodiment 2, the browser's timer ticks are routed through the tick( ) function call. Said call may call tock( ) with no reference, so the default Medium 0 will be served. The tock( ) call relegated to the gray CAa in Medium 0 and 1 will have the reference to Medium 1 and 2, respectively.

How this Invention is Different

In the world of CAa, the CAa of Embodiments 1 and 2 are too simple to be useful. Being left to themselves, they can only oscillate in the simplest checkerboard pattern, where the white squares become black and the black squares become white.

The inter-cellular memory restricts said CAa, making them somewhat similar to the CA models of exitable media, except in case of this invention it would be more appropriate to speak about excitable networks.

The biggest difference between the system of this invention and some other loosely similar prior arts is that in this invention CAa do not exclusively define the spatiotemporal patterns. The role of said CAa in said system can often be tentatively likened to the role of the gas in gas-filled lighting tubes.

In excitable media models, CAa have a state, which imposes so-called refractory time, during which an excited (turned “on”) CA can not re-excite the CA, which just exited said excited CAa, so the wave of excitement does not go back. In this invention, similar restriction can be imposed by the contents of inter-cellular memories, which users can change: If the way back is impassable, the wave goes forward. If the way back is passable, the user gets very simple oscillators to drive spatiotemporal patterns.

Many known CA can be adapted to inter-cellular memories, but they will not necessarily make a good educational toy. A system of this invention allows to design. The users who are not prepared to create their own CA, use stock CAa, change the colors of said CAa and shape the behavior of said CAa editing the contents of the inter-cellular memories to create spatiotemporal patterns they want.

### Preferred Embodiment

There is no preferred embodiment of this invention. Different uses pose different requirements. Computer simulation through software is more flexible, it costs less and provides richer functionality. The design of Embodiment 1 is no longer practical. However, since small children need sensorimotor experience of the kind that computer screens do not provide, the embodiments mimicking toy pegboards or mosaic sets are very desirable.

An extreme, opposite to entirely computer-simulated system, can be standalone CAa, complete with their own power sources. At minimum, said CAa must be able to indicate their states, access their peers and synchronize with them. Said standalone CAa may comprise inter-cellular memory. Alternatively, inter-cellular memory may comprise another kind of standalone devices.

Hybrid solutions are more realistic. Said solution may comprise a base fixing CAa in space, providing power, synchronization (timer ticks), access to inter-cellular medium, sound systems, controls, networks, peripherals, etc. Said base may be standalone (likely, having a computer inside), it may have its own peripherals and/or be tethered to an external computer.

Functionality can be distributed and redistributed among the components of such systems. For example, a fully functional standalone CAa may evolve to be symbolized by a translucent color cap, plain or shaped as a toy, lighted up by a source located inside said base.

The following examples of the diversity of technical solutions are not intended to be preferred, definitive or restrictive in any way: An inter-cellular memories may comprise mechanical members reflecting or blocking the light, or electrical switches of varying complexity, or a plurality of areas of dynamically allocated computer memory, or a combination whereof. Said combinations may include (but may not be limited to) the systems, wherein the designers build or draw symbolic representations of the networks, and use computer vision to convert said representations to computer data.

I claim:

1. A system to produce spatiotemporal patterns, said system comprising: a plurality of cellular automata (CAa), and a plurality of inter-cellular memories; the contents of said inter-cellular memories condition the changes in said CAa.

2. The system of claim 1, wherein the contents of said inter-cellular memories are used to allow or to forbid said CAa to influence the changes in the others of said CAa.

3. The system of claim 1, wherein the contents of said inter-cellular memories can point at the CAa to be influenced.

4. The system of claim 2, wherein the contents of said inter-cellular memories are used to time the changes in said CAa.

5. The system of claim 2, wherein said CAa are able to change immediately.

6. The system of claim 1, wherein the contents of said inter-cellular memories are used to provide said CAa with the indicia of the states of said CAa.

7. The system of claim 1, wherein said CAa, and said inter-cellular memories, are layered, so that every cellular automaton (CA) of said CAa is able to influence 8 of the others of said CAa in the same layer, and said CA is able to influence 2 of the others of said CAa in the adjacent layers.

8. The system of claim 1, wherein a plurality of said CA, said CAa combined with said inter-cellular memories, can be used as a single CA.

9. The system of claim 1, said system supporting scripting and synchronous scripting.

10. The system of claim 9, said system supporting a plurality of independently controlled and served media; said media available for cross-scripting and synchronous cross-scripting.
